(19) United States
(12) Patent Application Publication
(10) Pub. No.: US 2026/0274048 A1
(43) Pub. Date: Sep. 17, 2026

(54) VEHICLE AIR SUPPLY ADJUSTMENT MECHANISM

(71) Applicant: Honda Motor Co., Ltd., Tokyo (JP)

(72) Inventor: Yu NAKASHIMA, Tokyo (JP)

(73) Assignee: Honda Motor Co., Ltd., Tokyo (JP)

(21) Appl. No.: 19/386,153

(22) Filed: Nov. 11, 2025

(30) Foreign Application Priority Data
Mar. 14, 2025 (CN) 202510302336.1

(51) Int. Cl. B60H 1/34

(52) U.S. Cl. CPC B60H 1/3421; B60H 2001/3471

(57) ABSTRACT

Provided is a vehicle air supply adjustment mechanism adapted to be installed at an air supply outlet in a vehicle compartment and to adjust a direction of air delivered to the vehicle compartment through the air supply outlet, and includes: a first air direction adjustment component installed at the air supply outlet and rotatable in a first direction; a second air direction adjustment component installed at the air supply outlet and rotatable in a second direction different from the first direction; and a main rotating component connecting the first air direction adjustment component and the second air direction adjustment component, causing only the first air direction adjustment component to rotate in the first direction by rotating in a first rotation direction, and causing only the second air direction adjustment component to rotate in the second direction by rotating in a second rotation direction opposite to the first rotation direction.

### CROSS-REFERENCE TO RELATED APPLICATION

This application claims the priority benefit of China application serial no. 202510302336.1, filed on Mar. 14, 2025. The entirety of the above-mentioned patent application is hereby incorporated by reference herein and made a part of this specification.

### BACKGROUND

### Technical Field

The disclosure relates to an adjustment mechanism, and more particularly to a vehicle air supply adjustment mechanism.

### Description of Related Art

In recent years, in order to ensure access to more affordable, reliable, sustainable and advanced energy for more people, research and development related to vehicle operability that contributes to energy efficiency are being conducted. However, in technologies related to vehicle operability, the operability of vehicle air supply adjustment mechanisms is an issue.

In the conventional art, vehicle air supply adjustment mechanisms are adapted to be installed at air supply outlets in vehicle compartments and adjust the direction of air delivered to the vehicle compartments through the air supply outlets, and typically include a set of air direction adjustment components (e.g., one or more blades arranged side by side) rotatable in a single direction (e.g., left-right direction or up-down direction), that is, the air supply direction is adjusted by controlling the rotation direction of the air direction adjustment components (blades) (rotation angle relative to the air outlet, etc.). In addition, vehicle air supply adjustment mechanisms including multiple sets of air direction adjustment components rotatable in multiple different directions have also been developed, and for example, vehicle air supply adjustment mechanisms control the rotation of multiple sets of air direction adjustment components in different directions through a single power source combined with a drum having guide tracks, as disclosed in patent literature (Japanese Patent Publication H09-052519). However, when driving multiple sets of air direction adjustment components through a single power source combined with a drum having guide tracks, such an approach causes the multiple sets of air direction adjustment components to rotate simultaneously in multiple different directions, making it difficult to adjust to the desired air supply direction.

The disclosure may improve the operability of vehicle air supply adjustment mechanisms. Furthermore, it may further improves traffic safety and contributes to the development of sustainable transportation systems.

### SUMMARY

The disclosure provides a vehicle air supply adjustment mechanism capable of independently adjusting air supply directions in multiple different directions respectively to improve operability.

The disclosure provides a vehicle air supply adjustment mechanism adapted to be installed at an air supply outlet in a vehicle compartment and to adjust a direction of air delivered to the vehicle compartment through the air supply outlet, and includes: a first air direction adjustment component installed at the air supply outlet and rotatable in a first direction; a second air direction adjustment component installed at the air supply outlet and rotatable in a second direction different from the first direction; and a main rotating component connecting the first air direction adjustment component and the second air direction adjustment component, causing only the first air direction adjustment component to rotate in the first direction by rotating in a first rotation direction, and causing only the second air direction adjustment component to rotate in the second direction by rotating in a second rotation direction opposite to the first rotation direction.

Based on the above, in the vehicle air supply adjustment mechanism of the disclosure, the first air direction adjustment component and the second air direction adjustment component are each rotatable in the first direction (e.g., left-right direction) and the second direction (e.g., up-down direction). The main rotating component connects the first air direction adjustment component and the second air direction adjustment component, and by rotating in one of the first rotation direction (e.g., clockwise direction) and the second rotation direction (e.g., counterclockwise direction), only one of the first air direction adjustment component and the second air direction adjustment component is caused to rotate in the corresponding direction. In this way, multiple sets of air direction adjustment components may rotate independently, thereby enabling more precise adjustment of a required air supply direction. Accordingly, the vehicle air supply adjustment mechanism of the disclosure may independently adjust the air supply direction in multiple different directions, thereby improving operability.

In order to make the aforementioned features and advantages of the disclosure comprehensible, embodiments accompanied with drawings are described in detail below.

### BRIEF DESCRIPTION OF THE DRAWINGS

FIG. 1 is a cross-sectional schematic diagram of the vehicle air supply adjustment mechanism according to an embodiment of the disclosure when applied to an air supply outlet in a vehicle compartment;

FIG. 2 is a perspective schematic diagram of the vehicle air supply adjustment mechanism shown in FIG. 1;

FIG. 3 is a partial perspective schematic diagram of a part of the vehicle air supply adjustment mechanism shown in FIG. 2 related to the first air direction adjustment component and the main rotating component;

FIG. 4 is a partial top view schematic diagram of the part related to the first air direction adjustment component and the main rotating component shown in FIG. 3;

FIG. 5 is a partial perspective schematic diagram of a part of the vehicle air supply adjustment mechanism shown in FIG. 2 related to the second air direction adjustment component and the main rotating component;

FIG. 6 is a partial top view schematic diagram of the part related to the second air direction adjustment component and the main rotating component shown in FIG. 5.

### DESCRIPTION OF THE EMBODIMENTS

In an embodiment according to the disclosure, the vehicle air supply adjustment mechanism further includes: a first rotating component connecting the main rotating component to transmit power of the main rotating component rotating in the first rotation direction to the first air direction adjustment component; a first transformation component connecting the first air direction adjustment component and the first rotating component to drive the first air direction adjustment component to rotate in the first direction through power of the main rotating component rotating in the first rotation direction; a second rotating component connecting the main rotating component to transmit power of the main rotating component rotating in the second rotation direction to the second air direction adjustment component; and a second transformation component connecting the second air direction adjustment component and the second rotating component to drive the second air direction adjustment component to rotate in the second direction through power of the main rotating component rotating in the second rotation direction. The first rotating component rotates in the first rotation direction accordingly when the main rotating component rotates in the first rotation direction, and does not rotate when the main rotating component rotates in the second rotation direction, and the second rotating component rotates in the second rotation direction accordingly when the main rotating component rotates in the second rotation direction, and does not rotate when the main rotating component rotates in the first rotation direction.

In an embodiment according to the disclosure, the main rotating component, the first rotating component, and the second rotating component are coaxially arranged.

In an embodiment according to the disclosure, the main rotating component includes a first engaging portion that engages with the first rotating component and a second engaging portion that engages with the second rotating component, the first rotating component includes a first reverse rotation prevention portion that engages with the first engaging portion, the first reverse rotation prevention portion causes the first rotating component to rotate in the first rotation direction accordingly when the main rotating component rotates in the first rotation direction, and prevents rotation of the first rotating component in the second rotation direction when the main rotating component rotates in the second rotation direction, and the second rotating component includes a second reverse rotation prevention portion that engages with the second engaging portion, the second reverse rotation prevention portion causes the second rotating component to rotate in the second rotation direction accordingly when the main rotating component rotates in the second rotation direction, and prevents rotation of the second rotating component in the first rotation direction when the main rotating component rotates in the first rotation direction.

In an embodiment according to the disclosure, the first reverse rotation prevention portion includes a first tip portion that engages with a serrated edge of the first engaging portion, the first tip portion engages into the serrated edge of the first engaging portion when the main rotating component rotates in the first rotation direction, causing the first rotating component to rotate in the first rotation direction accordingly in conjunction with rotation of the main rotating component in the first rotation direction, and moves out of the serrated edge of the first engaging portion when the main rotating component rotates in the second rotation direction, causing the first rotating component not to rotate in the second rotation direction accordingly without being in conjunction with rotation of the main rotating component in the second rotation direction, the second reverse rotation prevention portion includes a second tip portion that engages with a serrated edge of the second engaging portion, and the second tip portion engages into the serrated edge of the second engaging portion when the main rotating component rotates in the second rotation direction, causing the second rotating component to rotate in the second rotation direction accordingly in conjunction with rotation of the main rotating component in the second rotation direction, and moves out of the serrated edge of the second engaging portion when the main rotating component rotates in the first rotation direction, causing the second rotating component not to rotate in the first rotation direction accordingly without being in conjunction with rotation of the main rotating component in the first rotation direction.

In an embodiment according to the disclosure, the first engaging portion and the second engaging portion are respectively disposed on opposite sides of the main rotating component to respectively connect the first rotating component and the second rotating component on opposite sides of the main rotating component.

In an embodiment according to the disclosure, the first rotating component includes a first protruding portion, the first protruding portion protrudes in a rotational axis direction of the first rotating component, the first transformation component includes a first extension portion and a first elongated hole portion, the first extension portion extends in the first direction and connects the first air direction adjustment component, the first elongated hole portion includes a first elongated hole extending in a third direction different from the first direction and the second direction, and engages with the first protruding portion through the first elongated hole, the second rotating component includes a second protruding portion, the second protruding portion protrudes in a rotational axis direction of the second rotating component, and the second transformation component includes a second extension portion and a second elongated hole portion, the second extension portion extends in the third direction and connects the second air direction adjustment component, the second elongated hole portion includes a second elongated hole extending in the first direction, and engages with the second protruding portion through the second elongated hole.

In an embodiment according to the disclosure, the first elongated hole is located within a range covered by the first rotating component when viewed from the second direction, and a length of the first elongated hole in the third direction is equal to or smaller than a diameter of the first rotating component, and the second elongated hole is located within a range covered by the second rotating component when viewed from the second direction, and a length of the second elongated hole in the first direction is equal to or smaller than a diameter of the second rotating component.

In an embodiment according to the disclosure, the first air direction adjustment component includes a plurality of first blades arranged in the first direction and capable of synchronously rotating in the first direction, and the second air direction adjustment component includes a single second blade extending in the first direction and rotatable in the second direction.

In an embodiment according to the disclosure, the vehicle air supply adjustment mechanism further includes: a power source connected to the main rotating component and driving the main rotating component to rotate in the first rotation direction or the second rotation direction through rotation of a drive shaft.

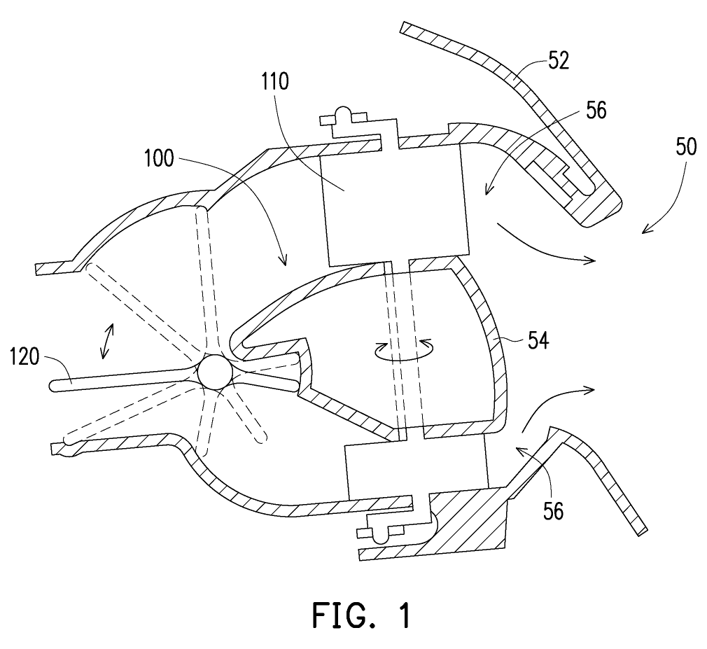

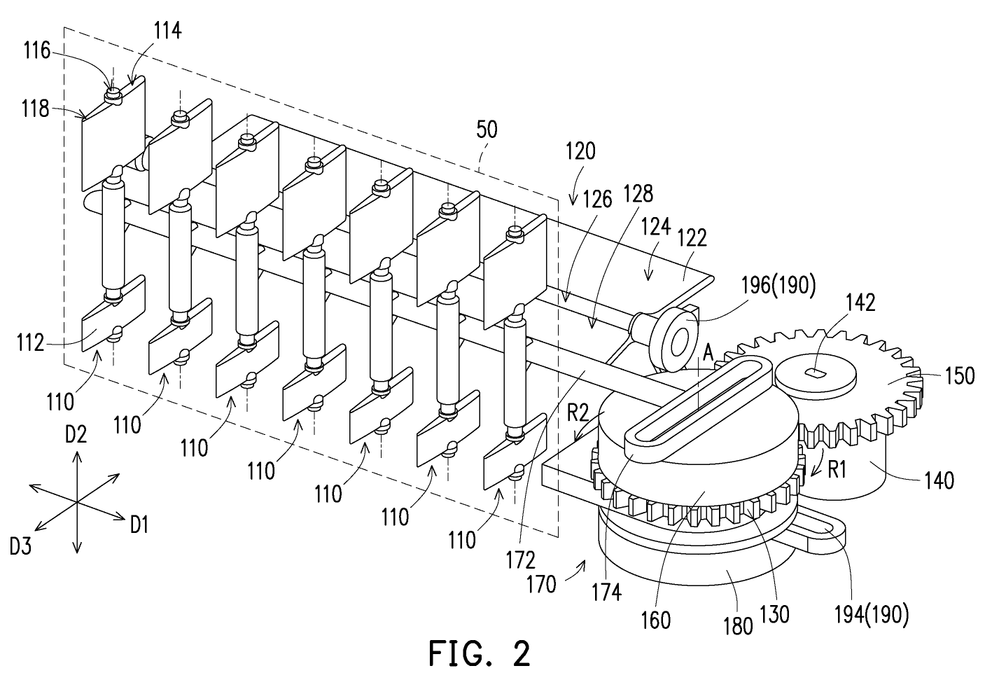

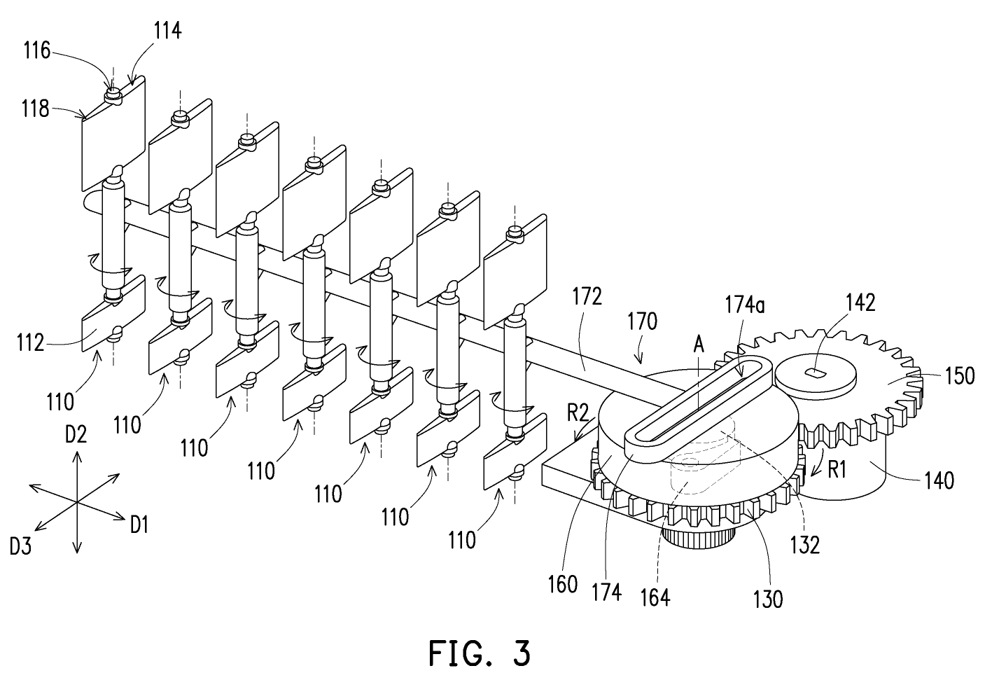

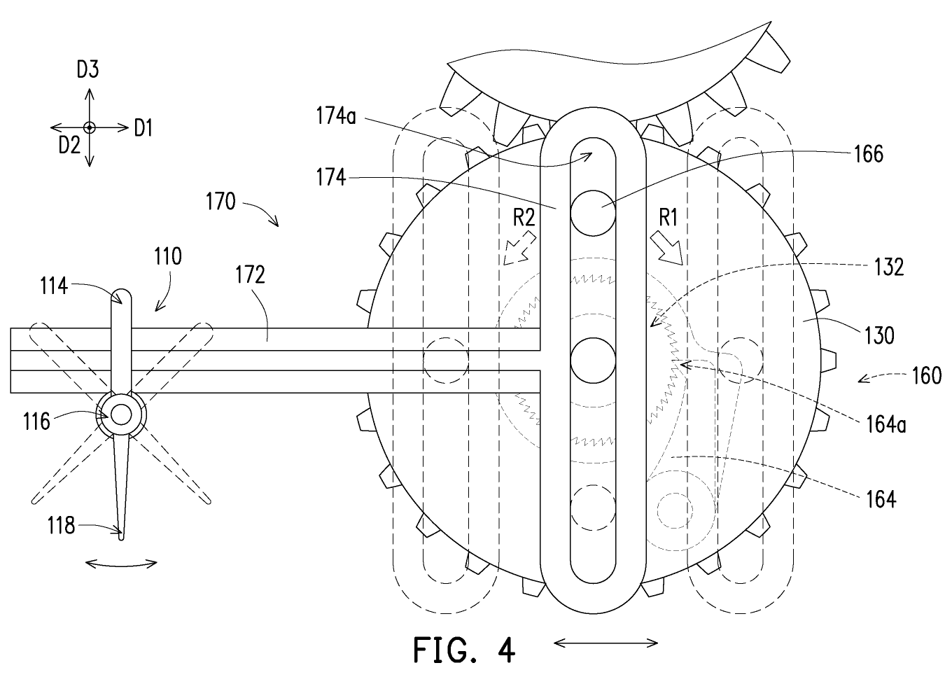

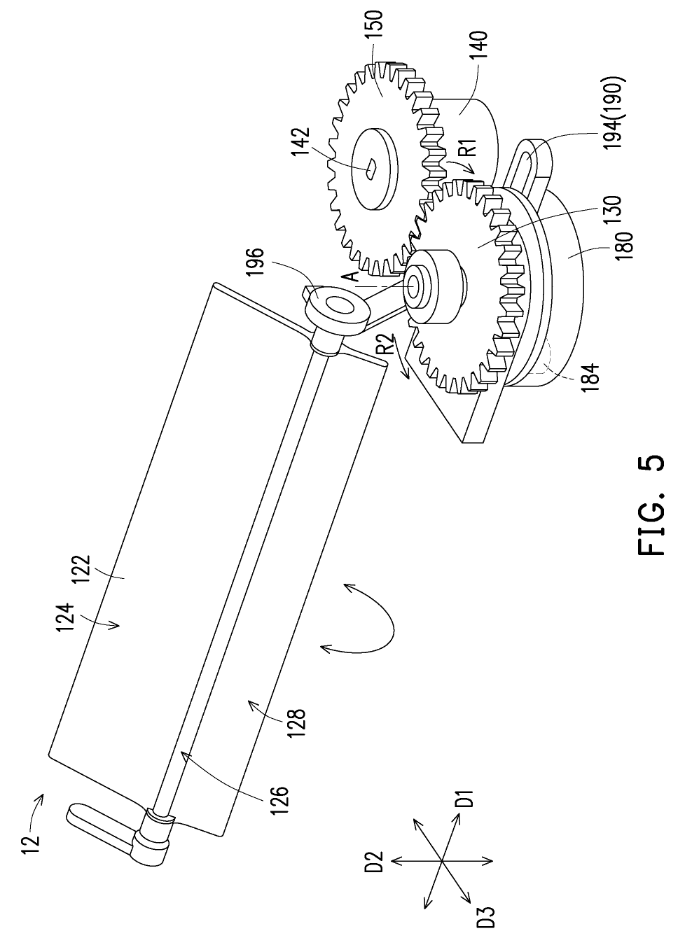

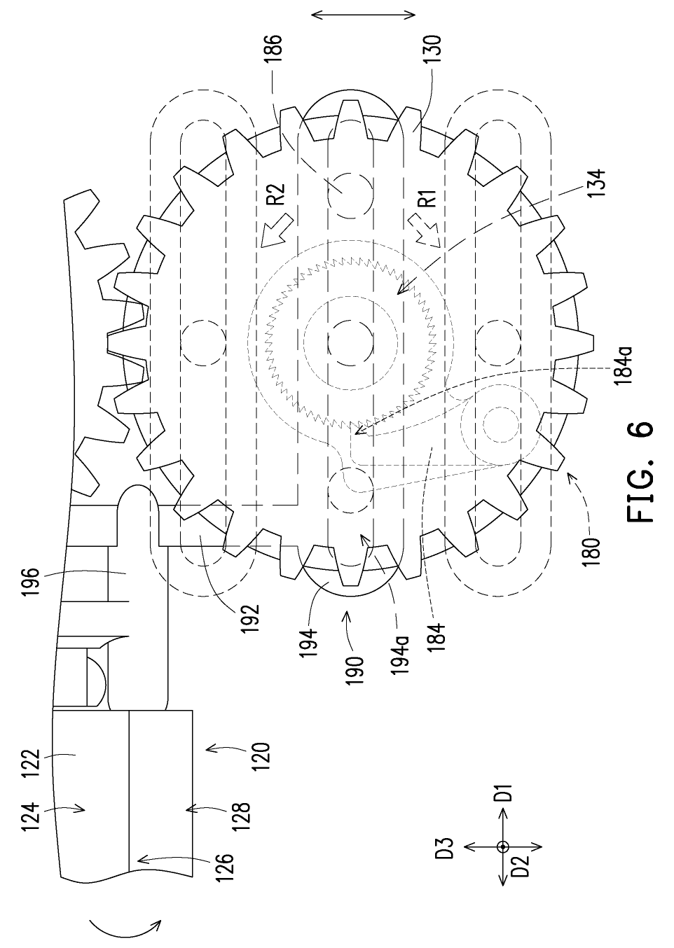

Reference will now be made in detail to the exemplary embodiments of the disclosure, and examples of the exemplary embodiments are illustrated in the accompanying drawings. FIG. 1 is a cross-sectional schematic diagram of the vehicle air supply adjustment mechanism according to an embodiment of the disclosure when applied to an air supply outlet in a vehicle compartment, FIG. 2 is a perspective schematic diagram of the vehicle air supply adjustment mechanism shown in FIG. 1, FIG. 3 is a partial perspective schematic diagram of a part of the vehicle air supply adjustment mechanism shown in FIG. 2 related to the first air direction adjustment component and the main rotating component, FIG. 4 is a partial top view schematic diagram of the part related to the first air direction adjustment component and the main rotating component shown in FIG. 3, FIG. 5 is a partial perspective schematic diagram of a part of the vehicle air supply adjustment mechanism shown in FIG. 2 related to the second air direction adjustment component and the main rotating component, and FIG. 6 is a partial top view schematic diagram of the part related to the second air direction adjustment component and the main rotating component shown in FIG. 5. The specific structure and operation process of the vehicle air supply adjustment mechanism 100 of the embodiment of the disclosure will be described below with reference to FIG. 1 to FIG. 6, but this is only one example, and the disclosure is not limited thereto.

Referring to FIGS. 1 and 2, in this embodiment, the vehicle air supply adjustment mechanism 100 is adapted to be installed at an air supply outlet 50 in a vehicle compartment and to adjust a direction of air delivered through the air supply outlet 50 to the vehicle compartment (e.g., the right side in FIG. 1). The vehicle air supply adjustment mechanism 100 includes a first air direction adjustment component 110, a second air direction adjustment component 120, and a main rotating component 130. The first air direction adjustment component 110 is installed at the air supply outlet 50 and is rotatable in a first direction D1 (e.g., left-right direction). The second air direction adjustment component 120 is installed at the air supply outlet 50 and is rotatable in a second direction D2 (e.g., up-down direction) that is different from the first direction D1 (here, orthogonal to the first direction D1 is taken as an example). The main rotating component 130 connects the first air direction adjustment component 110 and the second air direction adjustment component 120, causes only the first air direction adjustment component 110 to rotate in the first direction D1 by rotating in a first rotation direction R1 (e.g., clockwise direction), and causes only the second air direction adjustment component 120 to rotate in the second direction D2 by rotating in a second rotation direction R2 (e.g., counterclockwise direction) opposite to the first rotation direction R1.

Specifically, in this embodiment, as shown in FIGS. 1 and 2, the air supply outlet 50 in the vehicle compartment is, for example, an outlet where air generated by an air conditioning device (not shown) installed in the vehicle compartment flows into the vehicle compartment, and may be formed by a vehicle structure 52 near the air conditioning device. The vehicle air supply adjustment mechanism 100 is, for example, disposed in the vehicle structure 52 and located on a path between the air conditioning device and the air supply outlet 50. As an example, a decorative panel 54 may be installed at the air supply outlet 50 to prevent passengers from directly viewing internal structures (the vehicle air supply adjustment mechanism 100, air conditioning device, etc.) through the air supply outlet 50, and the part of the air supply outlet 50 not covered by the decorative panel 54 forms an air supply passage 56, allowing air whose air supply direction has been adjusted by the vehicle air supply adjustment mechanism 100 to be delivered to the vehicle compartment (e.g., the right side in FIG. 1).

Furthermore, in this embodiment, as shown in FIGS. 1 and 2, the first air direction adjustment component 110 is, for example, installed on an inner wall of the vehicle structure 52 constituting the air supply outlet 50, and is, for example, disposed with a rotating shaft extending in a second direction D2 (e.g., up-down direction) orthogonal to the first direction D1. Thus, the first air direction adjustment component 110 is able to change its rotation angle in the first direction D1 (e.g., left-right direction) by rotating relative to the air supply outlet 50 along an axis in the second direction D2. For example, if the position where the first air direction adjustment component 110 is substantially perpendicular to a plane corresponding to the air supply outlet 50 and blade surfaces on opposite sides of the first air direction adjustment component 110 face opposite sides in the first direction D1 (e.g., left side and right side) is taken as an original position of the first air direction adjustment component 110 (the state shown in FIG. 1 and FIG. 2), when the first air direction adjustment component 110 rotates relative to the air supply outlet 50 along an axis in the second direction D2 and rotates from the original position toward either of the opposite sides in the first direction D1 (left side or right side), the first air direction adjustment component 110 is able to incline toward a corresponding side of the opposite sides in the first direction D1 (left side or right side) relative to the air supply outlet 50 (not shown), thereby enabling adjustment of the orientation in the first direction D1 (leftward orientation or rightward orientation) of air delivered through the air supply outlet 50 to the vehicle compartment, but the disclosure is not limited thereto.

Further, in this embodiment, as shown in FIGS. 1 and 2, the second air direction adjustment component 120 is, for example, installed on an inner wall of the vehicle structure 52 constituting the air supply outlet 50, and is, for example, disposed with a rotating shaft extending in the first direction D1 (e.g., left-right direction) orthogonal to the second direction D2. The second air direction adjustment component 120 and the first air direction adjustment component 110 are offset in a third direction D3 (e.g., front-rear direction) that is different from the first direction D1 and the second direction D2 (here, orthogonal to the first direction D1 and the second direction D2 is taken as an example). Thus, the second air direction adjustment component 120 is able to change its rotation angle in the second direction D2 (e.g., up-down direction) by rotating relative to the air supply outlet 50 along an axis in the first direction D1. For example, if the position where the second air direction adjustment component 120 is substantially perpendicular to a plane corresponding to the air supply outlet 50 and blade surfaces on opposite sides of the second air direction adjustment component 120 face opposite sides in the second direction D2 (e.g., upper side and lower side) is taken as an original position of the second air direction adjustment component 120 (the state shown in FIGS. 1 and 2 ), when the second air direction adjustment component 120 rotates relative to the air supply outlet 50 along an axis in the first direction D1 and rotates from the original position toward either of the opposite sides in the second direction D2 (upper side or lower side), the second air direction adjustment component 120 is able to incline toward a corresponding side of the opposite sides in the second direction D2 (upper side or lower side) relative to the air supply outlet 50 (shown by dashed lines in FIG. 1), thereby enabling adjustment of the orientation in the second direction D2 (upward orientation or downward orientation) of air delivered through the air supply outlet 50 to the vehicle compartment, but the disclosure is not limited thereto. Furthermore, typically the first direction D1, the second direction D2, and the third direction D3 are orthogonal to each other, but depending on the shape of the air supply outlet 50, they may not necessarily be orthogonal.

As an example, in this embodiment, as shown in FIGS. 1 and 2, corresponding to the air supply outlet 50 having a dimension in the first direction D1 (left-right direction) greater than a dimension in the second direction D2 (up-down direction) and opening toward the third direction D3 (front-rear direction), the first air direction adjustment component 110 includes a plurality of first blades 112 arranged in the first direction D1 and capable of synchronously rotating in the first direction D1 (e.g., left-right direction), so as to rotate (change rotation angle) in the first direction D1 by rotating along an axis in the second direction D2. Correspondingly, the second air direction adjustment component 120 includes a single second blade 122 extending in the first direction D1 and rotatable in the second direction D2 (e.g., up-down direction), so as to rotate (change rotation angle) in the second direction D2 by rotating along an axis in the first direction D1. However, in other embodiments not shown, the second air direction adjustment component 120 may also include a plurality of second blades arranged in the second direction D2 and capable of synchronously rotating in the second direction D2 (up-down direction). Alternatively, the vehicle air supply adjustment mechanism 100 may also include air direction adjustment components (i.e., three or more sets) different from the first air direction adjustment component 110 and the second air direction adjustment component 120. As long as the vehicle air supply adjustment mechanism 100 is provided with two sets of air direction adjustment components respectively rotatable in different directions, the disclosure does not limit the specific structures and installation positions of the first air direction adjustment component 110 and the second air direction adjustment component 120, which may be adjusted according to requirements.

Furthermore, in this embodiment, as shown in FIG. 2, the main rotating component 130 is, for example, a disc-shaped rotating structure that rotates along an axis in the second direction D2 (e.g., up-down direction) and has a serrated edge, that is, the main rotating component 130 may be configured using a circular gear (but is not limited thereto). Moreover, the main rotating component 130 connects the first air direction adjustment component 110 and the second air direction adjustment component 120 through a structure described later, and transmits power generated by rotation in one of the first rotation direction R1 (e.g., clockwise direction) and the second rotation direction R2 (e.g., counterclockwise direction) to one of the first air direction adjustment component 110 and the second air direction adjustment component 120, thereby causing only one of the first air direction adjustment component 110 and the second air direction adjustment component 120 to rotate in a corresponding direction to adjust the direction of air delivered to the vehicle compartment through the air supply outlet 50. That is, during the process of the main rotating component 130 rotating in one of the first rotation direction R1 (e.g., clockwise direction) and the second rotation direction R2 (e.g., counterclockwise direction), only the corresponding one of the first air direction adjustment component 110 and the second air direction adjustment component 120 may rotate in the corresponding direction.

As an example, in this embodiment, as shown in FIG. 2, the vehicle air supply adjustment mechanism 100 further includes a power source 140 connected to the main rotating component 130 and drives the main rotating component 130 to rotate in the first rotation direction R1 or the second rotation direction R2 through rotational drive of a drive shaft 142. The power source 140 is, for example, a drive motor with the drive shaft 142 extending along the second direction D2 (e.g., up-down direction). Here, the power source 140 is connected to the main rotating component 130 through a transmission component 150. The transmission component 150 is, for example, a disc-shaped rotating structure mounted on the drive shaft 142 and rotating along an axis in the second direction D2 (e.g., up-down direction) and has a serrated edge, that is, the transmission component 150 may be configured using a circular gear (but is not limited thereto. For example, the main rotating component 130 and the power source 140 may also be connected through a belt or chain as the transmission component). Moreover, the transmission component 150 and the main rotating component 130 (e.g., circular gears) engage with each other through serrated edges, so the main rotating component 130 may rotate in one of the first rotation direction R1 (e.g., clockwise direction) and the second rotation direction R2 (e.g., counterclockwise direction) through driving by the power source 140 and transmission by the transmission component 150. However, in other embodiments not shown, the arrangement of the transmission component 150 may also be omitted so that the drive shaft 142 of the power source 140 directly connects to the main rotating component 130 for driving, or methods other than the power source 140 may be used to drive the main rotating component 130 (e.g., manually). The disclosure does not limit the specific structure and arrangement of the power source 140, transmission component 150, etc., which may be adjusted according to requirements.

Through the above arrangement, as shown in FIG. 1 and FIG. 2, in the vehicle air supply adjustment mechanism 100 of this embodiment, the first air direction adjustment component 110 and the second air direction adjustment component 120 are each rotatable in the first direction D1 (e.g., left-right direction) and the second direction D2 (e.g., up-down direction), the main rotating component 130 connects the first air direction adjustment component 110 and the second air direction adjustment component 120, and by rotating in one of the first rotation direction R1 (e.g., clockwise direction) and the second rotation direction R2 (e.g., counterclockwise direction), only one of the first air direction adjustment component 110 and the second air direction adjustment component 120 is rotated in the corresponding direction. In this way, multiple sets of air direction adjustment components (i.e., the first air direction adjustment component 110 and the second air direction adjustment component 120) may respectively rotate independently, thereby enabling more precise adjustment of the required air supply direction. Accordingly, the vehicle air supply adjustment mechanism 100 may respectively and independently adjust the air supply direction in multiple different directions to improve operability.

More specifically, in this embodiment, as shown in FIGS. 2 to 4 , the vehicle air supply adjustment mechanism 100 further includes a first rotating component 160 and a first transformation component 170. To clearly illustrate how the main rotating component 130 rotates the first air direction adjustment component 110 in the first direction D1 through rotation in the first rotation direction R1, FIG. 3 and FIG. 4 show parts related to the first air direction adjustment component 110 and the main rotating component 130, and omit parts related to the second air direction adjustment component 120. The first rotating component 160 connects the main rotating component 130 to transmit power of the main rotating component 130 rotating in the first rotation direction R1 (e.g., clockwise direction) to the first air direction adjustment component 110. The first transformation component 170 connects the first air direction adjustment component 110 and the first rotating component 160 to drive the first air direction adjustment component 110 to rotate in the first direction D1 (e.g., left-right direction) through power of the main rotating component 130 rotating in the first rotation direction R1. The first rotating component 160 rotates in the first rotation direction R1 accordingly when the main rotating component 130 rotates in the first rotation direction R1, and does not rotate when the main rotating component 130 rotates in the second rotation direction R2. That is, the first rotating component 160 only transmits power of the main rotating component 130 rotating in the first rotation direction R1 to the first air direction adjustment component 110, and does not transmit power of the main rotating component 130 rotating in the second rotation direction R2 to the first air direction adjustment component 110.

As an example, in this embodiment, as shown in FIGS. 2 to 4, the first rotating component 160 is, for example, a circular box-shaped component installed on one side (e.g., upper side) of the main rotating component 130. The main rotating component 130 has a first engaging portion 132 that engages with the first rotating component 160. Moreover, the first rotating component 160 has a first reverse rotation prevention portion 164 that engages with the first engaging portion 132. The first reverse rotation prevention portion 164 is, for example, disposed on the inner side of the first rotating component 160 adjacent to the first engaging portion 132, and has a first tip portion 164a that engages with the serrated edge of the first engaging portion 132. The serrated edge of the first engaging portion 132 is inclined toward one side (e.g., corresponding to the first rotation direction R1) as shown in FIG. 4, and only engages with the first tip portion 164a on one side (first rotation direction R1 side). In this way, the first rotating component 160 rotates along with the main rotating component 130, or is prevented from rotating, depending on whether the first tip portion 164a of the first reverse rotation prevention portion 164 engages with the serrated edge of the first engaging portion 132.

In detail, in this embodiment, as shown in FIG. 4, the first reverse rotation prevention portion 164 causes the first rotating component 160 to rotate accordingly in the first rotation direction R1 when the main rotating component 130 rotates in the first rotation direction R1 (e.g., clockwise direction). For example, when the main rotating component 130 rotates in the first rotation direction R1, the first tip portion 164a engages with the serrated edge of the first engaging portion 132 (inclined toward the first rotation direction R1 side), causing the first rotating component 160 to interlock with the rotation of the main rotating component 130 in the first rotation direction R1 (the first rotating component 160 and the main rotating component 130 do not move relatively) and rotate accordingly (with the main rotating component 130) in the first rotation direction R1. In contrast, the first reverse rotation prevention portion 164 prevents the rotation of the first rotating component 160 in the second rotation direction R2 when the main rotating component 130 rotates in the second rotation direction R2 (e.g., counterclockwise direction). For example, when the main rotating component 130 rotates in the second rotation direction R2, the first tip portion 164a moves out of the serrated edge of the first engaging portion 132, causing the first rotating component 160 not to interlock with the rotation of the main rotating component 130 in the second rotation direction R2 (the first rotating component 160 and the main rotating component 130 move relatively) and not rotate accordingly (not with the main rotating component 130) in the second rotation direction R2.

Thus, in this embodiment, the power of the main rotating component 130 rotating in the first rotation direction R1 is transmitted to the first air direction adjustment component 110 through the first rotating component 160, and the rotation of the main rotating component 130 in the second rotation direction R2 is not transmitted to the first air direction adjustment component 110 through the first rotating component 160, thereby enabling more precise independent driving of the first air direction adjustment component 110. However, the disclosure does not limit the specific structure and interlocking method of the first rotating component 160 (i.e., does not limit the specific structure and whether to dispose the first engaging portion 132 and the first reverse rotation prevention portion 164, etc.), which may be adjusted according to requirements.

Furthermore, in this embodiment, as shown in FIGS. 2 to 4 , the first transformation component 170 is, for example, an elongated connecting rod component that connects the first air direction adjustment component 110 and the first rotating component 160. The first rotating component 160 has a first protruding portion 166. The first protruding portion 166 is, for example, disposed on the surface of the first rotating component 160 and protrudes in the rotational axis direction of the first rotating component 160 (here being the second direction D2, i.e., the up-down direction). Moreover, the first transformation component 170 has a first extension portion 172 and a first elongated hole portion 174. The first extension portion 172 extends in the first direction D1 (e.g., left-right direction) and connects the first air direction adjustment component 110, for example, multiple first blades 112 are arranged along the first direction D1 and disposed on the rod-shaped first extension portion 172. The first elongated hole portion 174 has a first elongated hole 174a extending in a third direction D3 (e.g., front-rear direction) different from the first direction D1 and the second direction D2, and engages with the first protruding portion 166 through the first elongated hole 174a.

As an example, in this embodiment, as shown in FIGS. 3 and 4, the first extension portion 172 is disposed on the side of the first elongated hole portion 174 and located on the same horizontal plane (i.e., the plane formed by the first direction D1 and the third direction D3). Moreover, the first elongated hole 174a is located within the range covered by the first rotating component 160 when viewed from the second direction D2 (i.e., from the perspective of FIG. 4), and the length of the first elongated hole 174a in the third direction D3 is equal to or smaller than the diameter of the first rotating component 160. That is, the first elongated hole 174a does not exceed the edge of the first rotating component 160. Thus, the rotation of the first rotating component 160 in the first rotation direction R1 (e.g., clockwise direction) may be converted into movement of the first extension portion 172 in the first direction D1 through relative movement between the first protruding portion 166 and the first elongated hole 174a, thereby being converted into rotation of the first air direction adjustment component 110 in the first direction D1 (e.g., left-right direction). Moreover, the first elongated hole portion 174 where the first elongated hole 174a is located and the first rotating component 160 where the first protruding portion 166 is located are compactly arranged with each other to achieve structural miniaturization.

In detail, in this embodiment, as shown in FIG. 4, when the main rotating component 130 rotates in the first rotation direction R1 (e.g., clockwise direction) and causes the first rotating component 160 to rotate accordingly in the first rotation direction R1, the first rotating component 160 drives the first extension portion 172 to move in the first direction D1 through relative movement between the first protruding portion 166 and the first elongated hole 174a, thereby driving the first air direction adjustment component 110 to rotate in the first direction D1 (e.g., left-right direction). For example, if the position of the first rotating component 160 when the first protruding portion 166 is located at the end portion of the first elongated hole 174a corresponding to the upper side of FIG. 4 is taken as the origin position, then when the main rotating component 130 rotates in the first rotation direction R1 and causes the first protruding portion 166 to move from the upper side of FIG. 4 to the right side of FIG. 4 (equivalent to rotating 90 degrees from the origin position in the first rotation direction R1), the first rotating component 160 drives the first elongated hole portion 174 where the first elongated hole 174a is located to move from the center of FIG. 4 to the right side of FIG. 4 through the first protruding portion 166 (as shown by the dashed line on the right side of FIG. 4), thereby driving the rear end portion 114 of the first air direction adjustment component 110 to rotate toward the right side of FIG. 4 relative to the axial portion 116 and the front end portion 118 to rotate toward the left side of FIG. 4 through movement of the first extension portion 172 (as shown by the dashed line in FIG. 4).

Next, when the main rotating component 130 rotates in the first rotation direction R1 and causes the first protruding portion 166 to further move to the lower side of FIG. 4 (equivalent to rotating 180 degrees from the origin position in the first rotation direction R1), the first rotating component 160 drives the first elongated hole portion 174 where the first elongated hole 174a is located to move in a manner returning to the center of FIG. 4 through the first protruding portion 166 (as shown by the solid line in FIG. 4), thereby driving the rear end portion 114 of the first air direction adjustment component 110 to rotate toward the center relative to the axial portion 116 and the front end portion 118 to rotate toward the center through movement of the first extension portion 172 (as shown by the solid line in FIG. 4). Next, when the main rotating component 130 rotates in the first rotation direction R1 and causes the first protruding portion 166 to further move to the left side of FIG. 4 (equivalent to rotating 270 degrees from the origin position in the first rotation direction R1), the first rotating component 160 drives the first elongated hole portion 174 where the first elongated hole 174a is located to further move toward the left side of FIG. 4 through the first protruding portion 166 (as shown by the dashed line on the left side of FIG. 4), thereby driving the rear end portion 114 of the first air direction adjustment component 110 to rotate toward the left side of FIG. 4 relative to the axial portion 116 and the front end portion 118 to rotate toward the right side of FIG. 4 through movement of the first extension portion 172 (as shown by the dashed line in FIG. 4).

Thus, in this embodiment, the power of the main rotating component 130 rotating in the first rotation direction R1 is transmitted to the first air direction adjustment component 110 through the first rotating component 160 and the first transformation component 170, enabling independent driving of the first air direction adjustment component 110 through a simple structure. However, the disclosure does not limit the specific structure and interlocking method of the first transformation component 170 (i.e., it does not limit the specific structure and whether to provide the first extension portion 172 and the first elongated hole portion 174, etc.), which may be adjusted according to requirements.

Similarly, in this embodiment, as shown in FIGS. 2, 5 and 6, the vehicle air supply adjustment mechanism 100 further includes a second rotating component 180 and a second transformation component 190. To clearly illustrate how the main rotating component 130 causes the second air direction adjustment component 120 to rotate in the second direction D2 through rotation in the second rotation direction R2, FIGS. 5 and 6 show parts related to the second air direction adjustment component 120 and the main rotating component 130, and omit parts related to the first air direction adjustment component 110. The second rotating component 180 is connected to the main rotating component 130 to transmit power of the main rotating component 130 rotating in the second rotation direction R2 (e.g., counterclockwise direction) to the second air direction adjustment component 120. The second transformation component 190 is connected to the second air direction adjustment component 120 and the second rotating component 180 to drive the second air direction adjustment component 120 to rotate in the second direction D2 (e.g., up-down direction) through power of the main rotating component 130 rotating in the second rotation direction R2. The second rotating component 180 rotates accordingly in the second rotation direction R2 when the main rotating component 130 rotates in the second rotation direction R2, and does not rotate when the main rotating component 130 rotates in the first rotation direction R1. That is, the second rotating component 180 only transmits power of the main rotating component 130 rotating in the second rotation direction R2 to the second air direction adjustment component 120, and does not transmit power of the main rotating component 130 rotating in the first rotation direction R1 to the second air direction adjustment component 120.

As an example, in this embodiment, as shown in FIGS. 2, 5 and 6, the second rotating component 180 is, for example, a circular box-shaped component installed on another side (e.g., lower side) of the main rotating component 130. The main rotating component 130 has a second engaging portion 134 that engages with the second rotating component 180. Moreover, the second rotating component 180 has a second reverse rotation prevention portion 184 that engages with the second engaging portion 134. The second reverse rotation prevention portion 184 is, for example, disposed on an inner side of the second rotating component 180 adjacent to the second engaging portion 134, and has a second tip portion 184a that engages with a serrated edge of the second engaging portion 134. The serrated edge of the second engaging portion 134 is inclined toward one side (e.g., corresponding to the second rotation direction R2) as shown in FIG. 6, and engages with the second tip portion 184a only on one side (the second rotation direction R2 side). In this way, the second rotating component 180 rotates along with the main rotating component 130, or is prevented from rotating, depending on whether the second tip portion 184a of the second reverse rotation prevention portion 184 engages with the serrated edge of the second engaging portion 134.

Specifically, in this embodiment, as shown in FIG. 6, the second reverse rotation prevention portion 184 causes the second rotating component 180 to rotate accordingly in the second rotation direction R2 when the main rotating component 130 rotates in the second rotation direction R2 (e.g., counterclockwise direction). For example, when the main rotating component 130 rotates in the second rotation direction R2, the second tip portion 184a engages with the serrated edge of the second engaging portion 134 (inclined toward the second rotation direction R2 side), causing the second rotating component 180 to interlock with the rotation of the main rotating component 130 in the second rotation direction R2 (the second rotating component 180 and the main rotating component 130 do not move relatively) and rotate accordingly (with the main rotating component 130) in the second rotation direction R2. In contrast, the second reverse rotation prevention portion 184 prevents rotation of the second rotating component 180 in the first rotation direction R1 when the main rotating component 130 rotates in the first rotation direction R1 (e.g., clockwise direction). For example, when the main rotating component 130 rotates in the first rotation direction R1, the second tip portion 184a moves out of the serrated edge of the second engaging portion 134, causing the second rotating component 180 not to interlock with the rotation of the main rotating component 130 in the first rotation direction R1 (the second rotating component 180 and the main rotating component 130 move relatively) and not rotate accordingly (not with the main rotating component 130) in the first rotation direction R1.

Thus, in this embodiment, the power of the main rotating component 130 rotating in the second rotation direction R2 is transmitted to the second air direction adjustment component 120 through the second rotating component 180, and the rotation of the main rotating component 130 in the first rotation direction R1 is not transmitted to the second air direction adjustment component 120 through the second rotating component 180, thereby enabling more precise independent driving of the second air direction adjustment component 120. However, the disclosure does not limit the specific structure and interlocking method of the second rotating component 180 (i.e., does not limit the specific structure and arrangement of the second engaging portion 134 and the second reverse rotation prevention portion 184, etc.), which may be adjusted according to requirements.

Furthermore, in this embodiment, as shown in FIGS. 2, 5 and 6, the second transformation component 190 is, for example, an elongated connecting rod component that connects the second air direction adjustment component 120 and the second rotating component 180. The second rotating component 180 has a second protruding portion 186. The second protruding portion 186 is, for example, disposed on the surface of the second rotating component 180 and protrudes in the rotational axis direction of the second rotating component 180 (here, being the second direction D2, i.e., the up-down direction). The second transformation component 190 has a second extension portion 192 and a second elongated hole portion 194. The second extension portion 192 extends in the third direction D3 (e.g., the front-rear direction) and connects to the second air direction adjustment component 120. For example, an end portion of the second blade 122 in the first direction D1 is connected to the second extension portion 192 through a rotating shaft component 196. The second elongated hole portion 194 has a second elongated hole 194a extending in the first direction D1 (e.g., the left-right direction) and engages with the second protruding portion 186 through the second elongated hole 194a.

As an example, in this embodiment, as shown in FIGS. 5 and 6, the second extension portion 192 is disposed on the side of the second elongated hole portion 194 and located on the same horizontal plane (i.e., the plane formed by the first direction D1 and the third direction D3), and an end portion of the second extension portion 192 in the third direction D3 is connected to an end portion of the second air direction adjustment component 120 in the first direction D1 through the rotating shaft component 196 (as shown in FIG. 5, the second air direction adjustment component 120 is positioned above the second extension portion 192). The second elongated hole 194a is located within the range covered by the second rotating component 180 when viewed from the second direction D2 (i.e., from the perspective of FIG. 6), and the length of the second elongated hole 194a in the first direction D1 is equal to or smaller than the diameter of the second rotating component 180. That is, the second elongated hole 194a does not extend beyond the edge of the second rotating component 180. Thus, the rotation of the second rotating component 180 in the second rotation direction R2 (e.g., counterclockwise direction) may be converted into movement of the second extension portion 192 in the third direction D3 through the relative movement between the second protruding portion 186 and the second elongated hole 194a, thereby being converted into rotation of the second air direction adjustment component 120 in the second direction D2 (e.g., up-down direction) through rotation of the rotating shaft component 196. The second elongated hole portion 194 where the second elongated hole 194a is located and the second rotating component 180 where the second protruding portion 186 is located are compactly arranged with each other to achieve structural miniaturization.

Specifically, in this embodiment, as shown in FIG. 6, when the main rotating component 130 rotates in the second rotation direction R2 (e.g., counterclockwise direction) and causes the second rotating component 180 to rotate accordingly in the second rotation direction R2, the second rotating component 180 drives the rotating shaft component 196 to move in the third direction D3 through the relative movement between the second protruding portion 186 and the second elongated hole 194a, and the rotating shaft component 196 converts the movement of one end portion in the third direction D3 into rotation of the other end portion along the axis of the first direction D1 through its own rotation (as shown in FIG. 5), thereby driving the second air direction adjustment component 120 to be rotatable in the second direction D2 (e.g., up-down direction). For example, if the position of the second rotating component 180 when the second protruding portion 186 is located at the end portion of the second elongated hole 194a corresponding to the right side of FIG. 6 is taken as the origin position, then when the main rotating component 130 rotates in the second rotation direction R2 and causes the second protruding portion 186 to move from the right side of FIG. 6 to the upper side of FIG. 6 (equivalent to rotating 90 degrees from the origin position in the second rotation direction R2), the second rotating component 180 drives the second elongated hole portion 194 where the second elongated hole 194a is located to move from the center of FIG. 6 to the upper side of FIG. 6 through the second protruding portion 186 (as shown by the dashed line on the upper side of FIG. 6), thereby driving the rear end portion 124 of the second air direction adjustment component 120 to rotate toward the upper side of FIG. 5 relative to the axial portion 126 and the front end portion 128 to rotate toward the lower side of FIG. 5 through the movement of the second extension portion 192 and the axial rotation of the rotating shaft component 196 (as shown by the arrow in FIG. 5 and rotating 90 degrees).

Next, when the main rotating component 130 rotates in the second rotation direction R2 and causes the second protruding portion 186 to further move to the left side of FIG. 6 (equivalent to rotating 180 degrees from the origin position in the second rotation direction R2), the second rotating component 180 drives the second elongated hole portion 194 where the second elongated hole 194a is located to move in a manner returning to the center of FIG. 6 through the second protruding portion 186 (as shown by the solid line in FIG. 6), thereby driving the rear end portion 124 of the second air direction adjustment component 120 to rotate toward the front side of FIG. 5 relative to the axial portion 126 and the front end portion 128 to rotate toward the rear side of FIG. 5 through the movement of the second extension portion 192 and the axial rotation of the rotating shaft component 196 (as shown by the arrow in FIG. 5 and rotating 180 degrees). Next, when the main rotating component 130 rotates in the second rotation direction R2 and causes the second protruding portion 186 to further move to the lower side of FIG. 6 (equivalent to rotating 270 degrees from the origin position in the second rotation direction R2), the second rotating component 180 drives the second elongated hole portion 194 where the second elongated hole 194a is located to further move toward the lower side of FIG. 6 through the second protruding portion 186 (as shown by the dashed line on the lower side of FIG. 6), thereby driving the rear end portion 124 of the second air direction adjustment component 120 to rotate toward the lower side of FIG. 5 relative to the axial portion 126 and the front end portion 128 to rotate toward the upper side of FIG. 5 through the movement of the second extension portion 192 and the axial rotation of the rotating shaft component 196 (as shown by the arrow in FIG. 5 and rotating 270 degrees).

Thus, in this embodiment, the power of the main rotating component 130 rotating in the second rotation direction R2 is transmitted to the second air direction adjustment component 120 through the second rotating component 180 and the second transformation component 190, enabling independent driving of the second air direction adjustment component 120 through a simple structure. However, the disclosure does not limit the specific structure and interlocking method of the second transformation component 190 (i.e., does not limit the specific structure and whether to provide the second extension portion 192 and the second elongated hole portion 194, etc.), which may be adjusted according to requirements.

Further, in this embodiment, as shown in FIG. 2, in the case where the first rotating component 160 (combined with the first transformation component 170) and the second rotating component 180 (combined with the second transformation component 190) are provided to correspondingly transmit the rotational power of the main rotating component 130 (combined with the first engaging portion 132 and the second engaging portion 134) to the first air direction adjustment component 110 and the second air direction adjustment component 120, preferably, the first engaging portion 132 and the second engaging portion 134 are respectively provided on opposite sides of the main rotating component 130 to respectively connect the first rotating component 160 and the second rotating component 180 on the opposite sides of the main rotating component 130. Moreover, the main rotating component 130, the first rotating component 160, and the second rotating component 180 are coaxially arranged. That is, the rotation center of the disc-shaped main rotating component 130 (e.g., the center of the first engaging portion 132 and the center of the second engaging portion 134), the center point of the circular box-shaped first rotating component 160, and the center point of the circular box-shaped second rotating component 180 are coaxially arranged through an axis A extending in the second direction D2 (e.g., the up-down direction), so that when the main rotating component 130 rotates along the axis A in the first rotation direction R1, it drives the first rotating component 160 to coaxially rotate along the axis A in the first rotation direction R1, and when it rotates along the axis A in the second rotation direction R2, it drives the second rotating component 180 to coaxially rotate along the axis A in the second rotation direction R2.

Through the above arrangement, in this embodiment, the first rotating component 160 (combined with the first transformation component 170) for transmitting the power of the main rotating component 130 rotating in the first rotation direction R1 to the first air direction adjustment component 110 and the second rotating component 180 (combined with the second transformation component 190) for transmitting the power of the main rotating component 130 rotating in the second rotation direction R2 to the second air direction adjustment component 120 are respectively provided on opposite sides (e.g., upper and lower sides) of the main rotating component 130. The arrangement and operation of the first rotating component 160 and the second rotating component 180 do not interfere with each other, enabling smoother interlocking among the main rotating component 130, the first rotating component 160, and the second rotating component 180. Moreover, the first rotating component 160 and the second rotating component 180 respectively interlock more smoothly with the main rotating component 130 on the same axis (e.g., axis A), and the arrangement of the main rotating component 130, the first rotating component 160, and the second rotating component 180 is more compact, enabling structural miniaturization. However, the connection method of the main rotating component 130, the first rotating component 160, and the second rotating component 180, the specific structure of the first rotating component 160 and the second rotating component 180, and whether to provide the same may be adjusted according to requirements (e.g., the main rotating component 130 may also connect the first air direction adjustment component 110 and the second air direction adjustment component 120 respectively through other mechanisms), and the disclosure is not limited thereto.

In summary, in the vehicle air supply adjustment mechanism of the disclosure, the first air direction adjustment component and the second air direction adjustment component are each rotatable in the first direction (e.g., left-right direction) and the second direction (e.g., up-down direction). The main rotating component connects the first air direction adjustment component and the second air direction adjustment component, and by rotating in one of the first rotation direction (e.g., clockwise direction) and the second rotation direction (e.g., counterclockwise direction), only one of the first air direction adjustment component and the second air direction adjustment component is caused to rotate in the corresponding direction. In this way, multiple sets of air direction adjustment components may rotate independently, thereby enabling more precise adjustment of a required air supply direction. Preferably, the vehicle air supply adjustment mechanism further includes a first transformation component, a first rotating component, a second transformation component, and a second rotating component to transform the rotation of the main rotating component into the rotation of the corresponding air direction adjustment component in the corresponding direction, thereby improving operability. Accordingly, the vehicle air supply adjustment mechanism of the disclosure may independently adjust the air supply direction in multiple different directions, thereby improving operability.

Finally, it should be noted that the above embodiments are only used to illustrate the technical solutions of the disclosure and are not intended to limit it. Although the disclosure has been described in detail with reference to the above embodiments, persons of ordinary skill in the art should understand that they may still modify the technical solutions described in the above embodiments, or replace some or all of the technical features therein with equivalents, and that such modifications or replacements of corresponding technical solutions do not substantially deviate from the scope of the technical solutions of the embodiments of the disclosure.

What is claimed is:

1. A vehicle air supply adjustment mechanism adapted to be installed at an air supply outlet in a vehicle compartment and to adjust a direction of air delivered to the vehicle compartment through the air supply outlet, the vehicle air supply adjustment mechanism comprising:
a first air direction adjustment component installed at the air supply outlet and rotatable in a first direction;
a second air direction adjustment component installed at the air supply outlet and rotatable in a second direction different from the first direction; and
a main rotating component connecting the first air direction adjustment component and the second air direction adjustment component, causing only the first air direction adjustment component to rotate in the first direction by rotating in a first rotation direction, and causing only the second air direction adjustment component to rotate in the second direction by rotating in a second rotation direction opposite to the first rotation direction.

2. The vehicle air supply adjustment mechanism according to claim 1, further comprising:
a first rotating component connecting the main rotating component to transmit power of the main rotating component rotating in the first rotation direction to the first air direction adjustment component;
a first transformation component connecting the first air direction adjustment component and the first rotating component to drive the first air direction adjustment component to rotate in the first direction through power of the main rotating component rotating in the first rotation direction;
a second rotating component connecting the main rotating component to transmit power of the main rotating component rotating in the second rotation direction to the second air direction adjustment component; and
a second transformation component connecting the second air direction adjustment component and the second rotating component to drive the second air direction adjustment component to rotate in the second direction through power of the main rotating component rotating in the second rotation direction, wherein
the first rotating component rotates in the first rotation direction accordingly when the main rotating component rotates in the first rotation direction, and does not rotate when the main rotating component rotates in the second rotation direction, and
the second rotating component rotates in the second rotation direction accordingly when the main rotating component rotates in the second rotation direction, and does not rotate when the main rotating component rotates in the first rotation direction.

3. The vehicle air supply adjustment mechanism according to claim 2, wherein
the main rotating component, the first rotating component, and the second rotating component are coaxially arranged.

4. The vehicle air supply adjustment mechanism according to claim 2, wherein
the main rotating component comprises a first engaging portion that engages with the first rotating component and a second engaging portion that engages with the second rotating component,
the first rotating component comprises a first reverse rotation prevention portion that engages with the first engaging portion, the first reverse rotation prevention portion causes the first rotating component to rotate in the first rotation direction accordingly when the main rotating component rotates in the first rotation direction, and prevents rotation of the first rotating component in the second rotation direction when the main rotating component rotates in the second rotation direction, and
the second rotating component comprises a second reverse rotation prevention portion that engages with the second engaging portion, the second reverse rotation prevention portion causes the second rotating component to rotate in the second rotation direction accordingly when the main rotating component rotates in the second rotation direction, and prevents rotation of the second rotating component in the first rotation direction when the main rotating component rotates in the first rotation direction.

5. The vehicle air supply adjustment mechanism according to claim 4, wherein
the first reverse rotation prevention portion comprises a first tip portion that engages with a serrated edge of the first engaging portion,
the first tip portion engages into the serrated edge of the first engaging portion when the main rotating component rotates in the first rotation direction, causing the first rotating component to rotate in the first rotation direction accordingly in conjunction with rotation of the main rotating component in the first rotation direction, and moves out of the serrated edge of the first engaging portion when the main rotating component rotates in the second rotation direction, causing the first rotating component not to rotate in the second rotation direction accordingly without being in conjunction with rotation of the main rotating component in the second rotation direction,
the second reverse rotation prevention portion comprises a second tip portion that engages with a serrated edge of the second engaging portion, and
the second tip portion engages into the serrated edge of the second engaging portion when the main rotating component rotates in the second rotation direction, causing the second rotating component to rotate in the second rotation direction accordingly in conjunction with rotation of the main rotating component in the second rotation direction, and moves out of the serrated edge of the second engaging portion when the main rotating component rotates in the first rotation direction, causing the second rotating component not to rotate in the first rotation direction accordingly without being in conjunction with rotation of the main rotating component in the first rotation direction.

6. The vehicle air supply adjustment mechanism according to claim 4, wherein
the first engaging portion and the second engaging portion are respectively disposed on opposite sides of the main rotating component to respectively connect the first rotating component and the second rotating component on opposite sides of the main rotating component.

7. The vehicle air supply adjustment mechanism according to claim 4, wherein
the first rotating component comprises a first protruding portion, the first protruding portion protrudes in a rotational axis direction of the first rotating component,
the first transformation component comprises a first extension portion and a first elongated hole portion, the first extension portion extends in the first direction and connects the first air direction adjustment component, the first elongated hole portion comprises a first elongated hole extending in a third direction different from the first direction and the second direction, and engages with the first protruding portion through the first elongated hole,
the second rotating component comprises a second protruding portion, the second protruding portion protrudes in a rotational axis direction of the second rotating component, and
the second transformation component comprises a second extension portion and a second elongated hole portion, the second extension portion extends in the third direction and connects the second air direction adjustment component, the second elongated hole portion comprises a second elongated hole extending in the first direction, and engages with the second protruding portion through the second elongated hole.

8. The vehicle air supply adjustment mechanism according to claim 7, wherein
the first elongated hole is located within a range covered by the first rotating component when viewed from the second direction, and a length of the first elongated hole in the third direction is equal to or smaller than a diameter of the first rotating component, and
the second elongated hole is located within a range covered by the second rotating component when viewed from the second direction, and a length of the second elongated hole in the first direction is equal to or smaller than a diameter of the second rotating component.

9. The vehicle air supply adjustment mechanism according to claim 1, wherein
the first air direction adjustment component comprises a plurality of first blades arranged in the first direction and capable of synchronously rotating in the first direction, and
the second air direction adjustment component comprises a single second blade extending in the first direction and rotatable in the second direction.

10. The vehicle air supply adjustment mechanism according to claim 1, further comprising:
a power source connected to the main rotating component and driving the main rotating component to rotate in the first rotation direction or the second rotation direction through rotation of a drive shaft.
